(19) United States
(12) Patent Application Publication
(10) Pub. No.: US 2005/0015225 A1
(43) Pub. Date: Jan. 20, 2005

(54) Methods for determining optimal doses for a first investigational administration in humans

(76) Inventors: Christopher J. Godfrey, Natick, MA (US); Amit Roy, Plainsboro, NJ (US); Ene I. Ette, Framingham, MA (US)

Correspondence Address: VERTEX PHARMACEUTICALS INC., 130 WAVERLY STREET, CAMBRIDGE, MA, 02139-4242, US

(21) Appl. No.: 10/840,197

(22) Filed: May 6, 2004

Related U.S. Application Data
(60) Provisional application No. 60/468,678, filed on May 7, 2003.

(51) Int. Cl. G06F 17/10

(52) U.S. Cl. 703/2

(57) ABSTRACT

The present invention provides a method for determining an optimal dose range of a compound for a first investigational administration of that compound in a human. The method involves stochastic simulation of allometric parameters to produce outcome distributions that provide a basis for selecting an optimal dose range. The present invention also provides optimal doses of compounds under clinical evaluation in the first administration of such compounds to humans.

### CROSS-REFERENCE TO RELATED APPLICATIONS

The present application claims the benefit of United States Provisional Application No. 60/468,678, filed May 7, 2003, the entire disclosure whereof is incorporated herein by reference.

### TECHNICAL FIELD OF THE INVENTION

The present invention relates to a method for determining an optimal dose range of a compound for a first investigational administration of that compound in a human. The method involves stochastic simulation of allometric parameters to produce outcome distributions that provide a basis for selecting an optimal dose range. The present invention also relates to optimal doses of compounds for use in the first investigational administration of such compounds to humans.

### BACKGROUND OF THE INVENTION

A critical step in drug development is the transition from studies conducted on animals to in vivo testing in humans. The first administration of a compound under investigation to a human, as part of a first-in-human study (hereinafter “FIH study”), has to be conservative in dosage amount for safety reasons. Yet, the fiscal imperatives of drug development argue for an aggressive approach for testing in humans so that the first observable pharmacologic effect and the maximum tolerated dose levels are rapidly identified. This is especially true for compounds that will be given to a target human population during Phase I (e.g., anticancer agents, AIDS drugs, etc.).

Data obtained in the pharmacological and toxicological studies conducted on animals are a vital link in the prediction of pharmacokinetic/pharmacodynamic parameters in humans. The extrapolation of animal data to humans, known as interspecies scaling, is useful in translating dosage regimens from animals to humans. Interspecies scaling is based on the assumption of anatomical, physiological, and biochemical similarities across animal species. One common tool to perform interspecies scaling is allometric scaling.

Allometric scaling relates a pharmacokinetic parameter, e.g., clearance, to total body weight (BW) as follows:
Y=α(BW)^{β} (1);
wherein Y is a pharmacokinetic parameter and BW is the body weight of the animal studied. α and β are allometric parameters. Typically, allometric scaling is applied retrospectively to pre-clinical interspecies animal data in order to extract the allometric parameters. Then, the allometric parameters so extracted are applied prospectively to compute pharmacokinetic and pharmacodynamic responses in humans. See, e.g., “The Pharmacokinetic Principles Behind Scaling From Preclinical Results To Phase I Protocols,” Mahmood, I., and Balian, J. D., Cli. Pharmco. Kinet., 1999 Jan: 36(1), incorporated herein by reference; “First-Time-in-Human Dose Selection: Allometric Thoughts and Perspectives,” Boxenbaum, H. and DiLea, C., J. Clin. Pharmacol., 1995; 35:957-966, incorporated herein by reference; “Man Versus Beast: Pharmacokinetic Scaling In Mammals,” Mordenti, J., Journal of Pharmaceutical Sciences, Vol. 75, No. 11, November 1996, incorporated herein by reference; “Interspecies Scaling And Comparisons In Drug Development And Toxicokinetics,” Ings, R. M. J., Xenobiotica, 1990, Vol. 20, No. 11, pp. 1201-1231, incorporated herein by reference; “Computer-assisted drug development (CADD) an emerging technology for designing first-time-in-man and proof-of-concept studies from preclinical experiments,” Gomeni, R. et al., European Journal of Pharmaceutical Sciences, vol 13 (2001), pp. 261-270, incorporated herein by reference; “Interspecies Scaling, Allometry, Physiological Time, And The Ground Plan Of Pharmacokinetics,” Boxenbaum, H., Journal of Pharmacokinetics and Biopharmaceutics, Vol. 10, No. 2, pp. 201-227, 1982, incorporated herein by reference.

Typically, allometric scaling methods are applied deterministically to predict human pharmacokinetic parameters; i.e., the relationship between a pharmacokinetic parameter, such as clearance, has been treated as fixed and not subject to any uncertainty despite the known limitations of using animal data to predict human data. Consequently, any uncertainty in the allometric parameters determined from that relationship will lead to uncertainty in the extrapolation of animal data to predict human data.

Thus, there is a need for a method that addresses the uncertainty in the estimates of the allometric parameters. There is also a need for a method for determining optimal dose ranges for administering a compound under investigation for the first time in a human.

### SUMMARY OF THE INVENTION

The present invention provides a method for determining the distribution of at least one outcome resulting from the administration of a compound to at least one human, comprising the steps of:
(a) using non-linear mixed effects modeling to determine a value and a standard error for each of a plurality of allometric parameters ;
(b) inputting said value and said standard error of at least one of said plurality of allometric parameters into a stochastic pharmacokinetic model, wherein said allometric parameter is designated as a random variable; and
(c) using said stochastic pharmacokinetic model to computationally simulate administration of said compound to said human to produce said distribution of said outcome.

The present invention also provides optimal doses of compounds under clinical evaluation in the first administration of such compounds to humans.

### DESCRIPTION OF THE FIGURES

FIG. 1 depicts the population pharmacokinetics as described by non-linear mixed effects allometric modeling.

FIG. 2 depicts the correlation between the predicted and the observed VX-702 concentration.

FIG. 3 depicts the stochastic pharmacokinetic model used to computationally simulate the administration of VX-702 to human subjects.

FIG. 4 depicts the distribution of the predicted AUC for various dose levels.

FIG. 5 depicts the predicted distribution of average concentration for various dose levels.

FIG. 6 depicts the probability of the predicted median concentration for various dose levels.

### DETAILED DESCRIPTION OF THE INVENTION

The present invention provides a method for determining the distribution of at least one outcome resulting from the administration of a compound to at least one human, comprising the steps of:
(a) using non-linear mixed effects modeling to determine a value and a standard error for each of a plurality of allometric parameters;
(b) inputting said value and said standard error of at least one of said plurality of allometric parameters into a stochastic pharmacokinetic model, wherein said allometric parameter is designated as a random variable; and
(c) using said stochastic pharmacokinetic model to computationally simulate administration of said compound to said human to produce said distribution of said outcome.
“Non-linear mixed effects modeling” as used herein means a statistical modeling method used to describe, e.g., longitudinal data, wherein the model comprises both, fixed and random effects, and wherein the model is non-linear. See, e.g., “Mixed-Effects Models in S and S-Plus,” Statistics and Computing, Ed. Jose C. Pinheiro and Douglas M. Bates, Springer-Verlag New York, Inc (2000), incorporated herein by reference.

“Standard error” as used herein is a measure of the imprecision associated with the value of an allometric parameter. The standard error is outputted by the non-linear mixed effects modeling.

“Allometric parameter” as used herein means a scaling parameter produced by correlating a pharmacokinetic parameter to body weight across one or more animal species.

The allometric scaling equation typically is:
Y=α(BW)^{β} (1);
wherein Y is a pharmacokinetic parameter such as clearance, volume of distribution, etc., and BW is the body weight of the animal studied. α and β are allometric parameters. Each allometric parameter has a non-zero value and a standard error associated with that value.

Examples of such pharmacokinetic parameters are clearance, volume of distribution, and inter-compartmental clearance. Thus, each such pharmacokinetic parameter has an associated pair of allometric parameters, α and β, based on the above equation (1).

“Stochastic pharmacokinetic model” as used herein means a mathematical model for simulation of a clinical trial of a compound under investigation, wherein at least one of the allometric parameters is designated as a random variable.

### Step (a):

In the first step of the present invention, typically, an investigational compound is administered to a plurality of animals. Typically, more than one species are used in the evaluation. One or more pharmacokinetic parameters are determined and the data are correlated with the body weight of the animal and allometrically scaled across the plurality of animals.

For example, following administration of a compound to an animal, the compound concentration in, e.g., plasma, is measured at various time points post dose. An equation describing one or more suitable pharmacokinetic models (e.g. one-compartment model or a multi-compartment model) is fitted to these data using, e.g., non-linear mixed effects modeling. That equation is parameterized using suitable pharmacokinetic model parameters such as clearance and/or volume of distribution. These pharmacokinetic parameters are expressed as a function of body weight, and the associated allometric parameters are then determined.

### Step (b)

In the second step of the present invention, at least one allometric parameter is input as a random variable in a stochastic pharmacokinetic model.

The use of allometric parameters as random variables in a stochastic approach to human pharmacokinetic predictions is a key feature of the present invention. In the prior art, the allometric parameters, e.g., the relationship between a pharmacokinetic parameter such as clearance and body weight, have been treated as fixed and not subject to uncertainty despite the known limitations of using animal data to predict human data. Therefore, extrapolation of animal pharmacokinetics to humans is subject to varying amounts of uncertainty, depending on the animal species studied, the compound under investigation, and the study designs employed. However, applicant's invention uses a stochastic approach to interspecies allometric scaling. One measure of the degree of uncertainty in the allometric scaling is the standard errors in the estimates of the allometric parameters. When the allometric scaling relationship correlates well with the animal data, then the standard error is small. When the allometric scaling relationship correlates poorly with the animal data, then the standard error is large. Thus, applicants have recognized, for the first time, that the standard error in the allometric parameter estimates can be used to quantify the uncertainty when extrapolating the animal data for human pharmacokinetic /PD predictions. This allows a more informed selection of doses to investigate in the first study representing administration of the investigational compound to human subjects.

Typically, each allometric parameter that is input as a random variable has an initial mean value equal to the value of said allometric parameter, and a standard deviation equal to said standard error of said allometric parameter. The initial mean value and the standard error are as determined from the allometric scaling of the animal data in step (a).

According to a preferred embodiment, each of the allometric parameter is designated as a random variable with a specified probability density in the stochastic pharmacokinetic model. Probability density, as used herein, describes the probability of observing a specific value predicated on a certain probability distribution.

According to another preferred embodiment, the specified probability density of each random variable independently corresponds to either a normal distribution or a lognormal distribution.

### Step (c)

In the third step of the present invention, the stochastic pharmacokinetic model is used to computationally simulate the administration of the compound to at least one human. Typically, a plurality of administrations to a group of humans is simulated. The simulation produces the expected distribution of one or more outcomes of the administration of the compound to humans.

Typically, such a computational simulation allows for variability in the distribution of human body weight and random inter-individual variability. However, applicants' invention allows for building into such a simulation the variability associated with the allometric scaling across the animal species. Thus, the distribution outcome produced by the simulation reflects, in part, the uncertainty inherent in the allometric scaling across the animal species. Consequently, the distribution outcome produced by the present invention is more useful in predicting the range of possible and probable pharmacokinetic/pharmacodynamic responses that might arise from administration of the compound under investigation to human subjects.

Commercial software packages may be readily employed for conducting such simulations. An example of such a commercial software package is Pharsight® Trial Simulator™. See, also, e.g., “Computer-assisted drug development (CADD): an emerging technology for designing first-time-in-man and proof-of-concept studies from preclinical experiments,” Gomeni, R. et al., European Journal of Pharmaceutical Sciences, 13 (2001) 261-270, incorporated herein by reference.

Preferred outcomes produced by the present invention include, e.g., AUC, Cmax, C₂₄, Cavg, Cmin, or a pharmacodynamic response. More preferred outcomes are AUC, C_{avg} or Cₘₐₓ. A preferred pharmacodynamic response outcome is, e.g., inhibition or stimulation of a biological target.

### Selection of Dose Levels

The distribution of an outcome produced by the present invention is useful for selecting the initial (first) dose to be administered to humans. It is also useful for selecting doses to administer to humans in the context of a single dose, dose escalation study.

A commonly used consideration in selecting an initial dose is the safety factor. The safety factor provides a measure of risks associated with administering a compound to a human for the first time. The safety factor is the ratio of a measure of exposure such as AUC associated with the no-adverse-effect-level and the anticipated exposure, e.g., AUC, in humans. A large safety factor suggests lesser risks in administering a compound to a human for the first time.

For example, based on a distribution of an outcome such as AUC, an anticipated safety factor can be determined based on the mean AUC value predicted for humans or, e.g., the 95^{th} percentile AUC value. This latter safety factor, based on the 95^{th} percentile AUC value, would characterize the risk to human subjects for individuals with extreme values of AUC. And, it would also characterize the risk arising from uncertainty in the allometric relationships. An allometric relationship characterized by a high degree of uncertainty, i.e., large standard errors, will result in a broad distribution of AUC values. Therefore, the safety factor determined from the 95^{th} percentile anticipated AUC would be much smaller resulting in a more conservative selection for the initial dose.

Thus, according to an alternative embodiment, the present invention provides a method of determining a priori an optimal dose range for administration of a compound for the first time to humans.

The optimal dose range provides a minimum dose level and a maximum dose level to be investigated in humans. The minimum dose level is an amount of the compound under investigation required for a desired level of safety and, optionally, a desired minimum pharmacological effect in a human. The maximum dose level is an amount of the compound under investigation required for a desired level of safety and, optionally, a desired maximum pharmacological effect in a human.

Such an administration of the compound for the first time to humans can be part of a single dose study, wherein a single dose amount from within the optimal dose range is selected for administration to one or more humans. Alternatively, such an administration can be part of an escalation study, wherein one or more humans are administered a series of escalating dose amounts. In such an escalation study, the optimal dose range is useful in deciding the minimum and maximum dose levels.

According to an alternate embodiment, the present invention provides optimal doses of compounds under investigation, wherein the doses are determined according to the methods of the present invention. Such optimal doses are useful for administration to humans for the first time.

In order that this invention be more fully understood, the following examples are set forth. These examples are for the purpose of illustration only, and are not to be construed as limiting the scope of the invention in any way.

### EXAMPLE 1

To identify the safety factors of an initial dose of an investigational compound, VX-702, to be administered to healthy human volunteers in a first-time-in-human study using an interspecies allometric scaling approach combined with a stochastic clinical trial simulation.

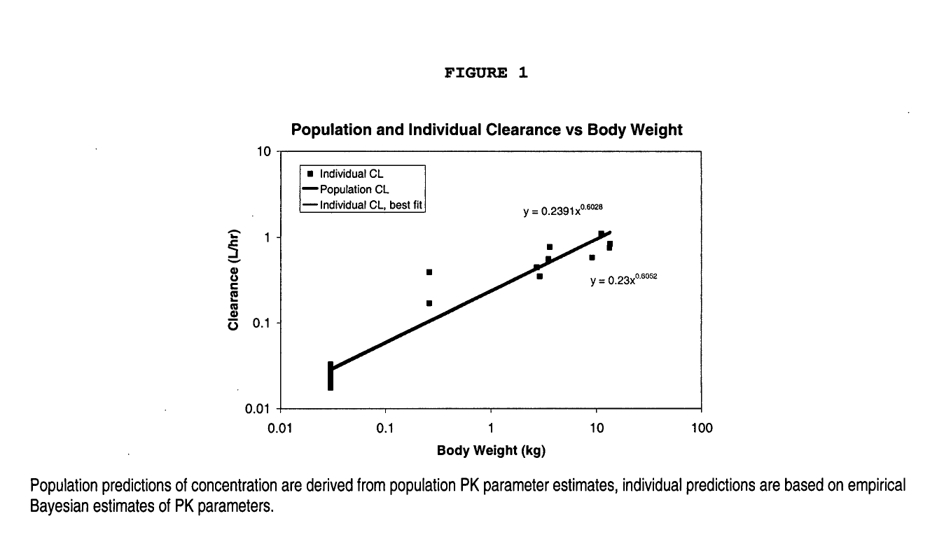

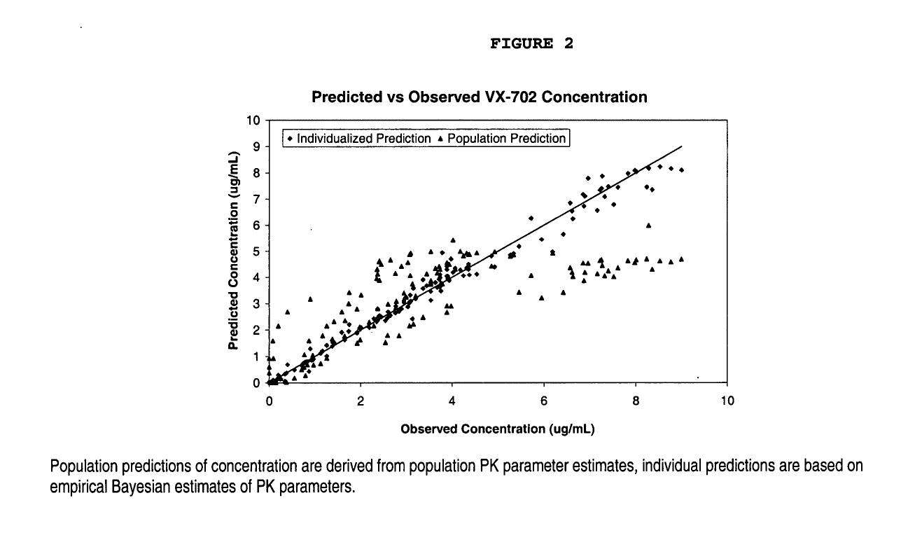

In the first step, allometric parameters were determined as follows:
One compartment pharmacokinetic model was fitted to concentration-time data obtained from 11 mice, 2 rats, 4 dogs, and 4 monkeys following i.v. administration of VX-702;
Population pharmacokinetic were described by a Nonlinear Mixed Effects Allometric Model (FIG. 1 and FIG. 2); * Fixed Effects: Population geometric means (μ) of pharmacokinetic parameters (clearance, CL and volume distribution, V) were described by a power function of body weight:
   μₚ=□(BW)^{□□};
   where P is CL or V (Table 1);
Random Effects: Population variability in pharmacokinetic model parameters was characterized by a log-normal distribution:
   p ᵢ˜LN(μₚ, ωₚ);

where Pi is the pharmacokinetic parameter value (CLᵢ or Vᵢ) for the i^{th} animal and ωₚ is the geometric standard deviation.

TABLE 1

| | | | Standard |
|---|---|---|---|
| | Parameter | Estimate | Error |
| Clearance | α_{CL} | 0.239 | 0.0359 |
| | β_{CL} | 0.603 | 0.0419 |
| | ω_{CL} | 0.451 | 0.118 |
| Volume | α_{V} | 1.17 | 0.125 |
| | β_{V} | 0.961 | 0.0609 |
| | ω_{V} | 0.402 | 0.0478 |

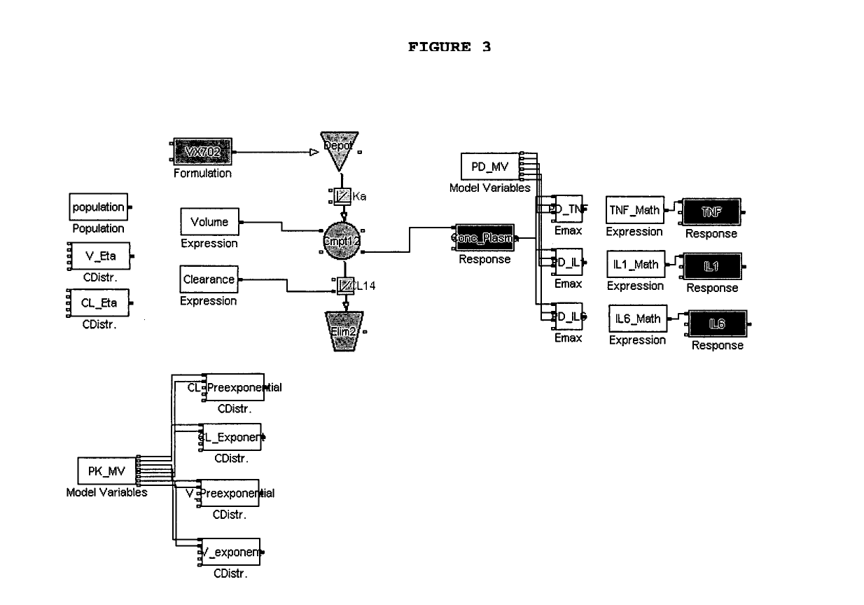

In the second step, the above allometric parameters, inter alia, were input into a stochastic pharmacokinetic model as random variables (FIG. 3):
Allometric parameter estimates & standard errors were input into the model;
Assumptions of typical bioavailability (25, 50%) and absorption rate constant (0.1, 0.4 hr⁻¹) were input;
Typical distribution of body weights in study population was input.

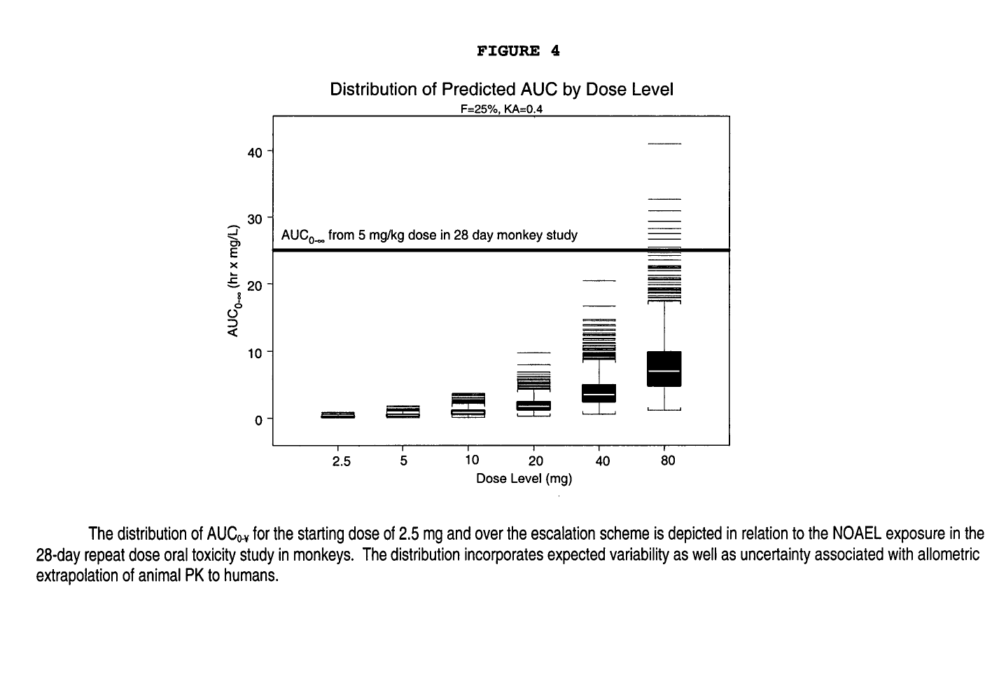

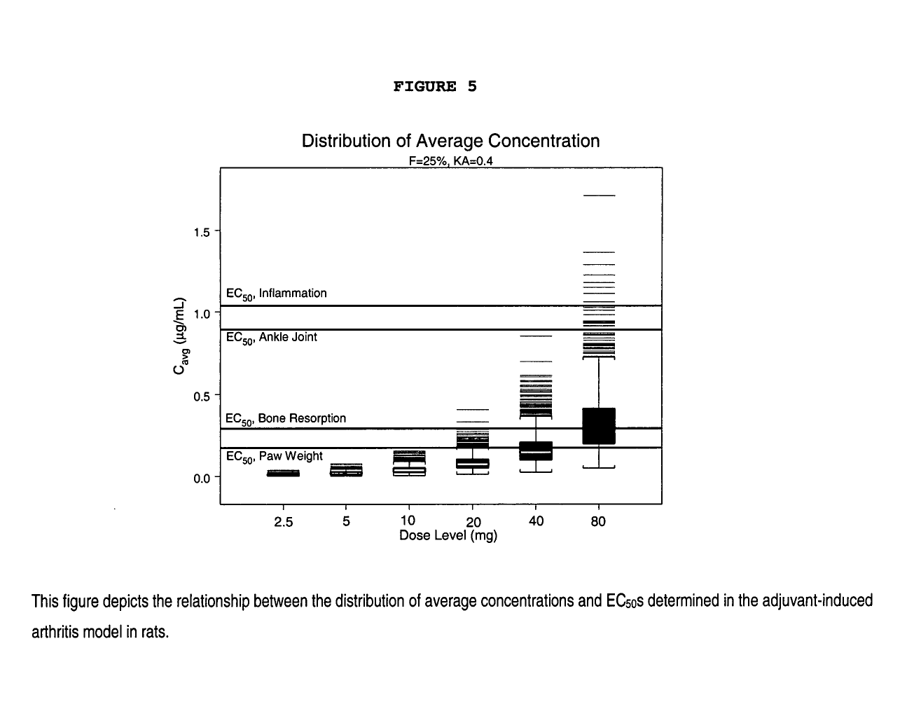

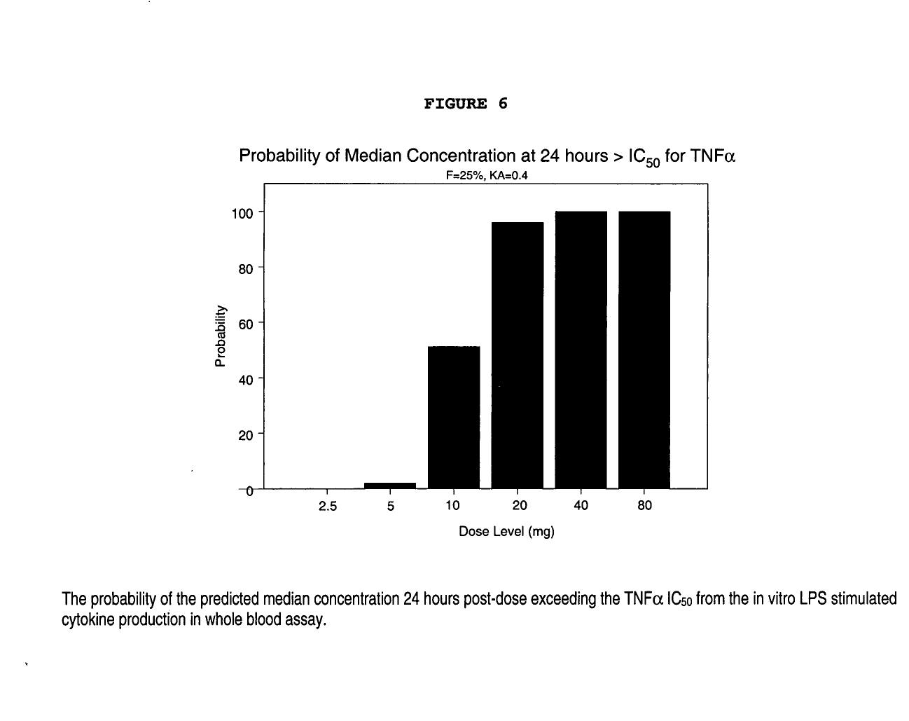

In the third step, the administration of VX-702 to human subjects was computationally simulated (FIG. 3). 250 trials of 12 human subjects were simulated for various starting doses:
250 trials of 12 subjects each simulated for various starting doses (Results presented for selected starting dose of 2.5 mg);
Allometric parameter values randomly selected from distribution described by mean and standard error;
Subject body weight and intersubject variability randomly selected from specified distributions.
   The output of the computational simulation consisted of the distribution of the metrics that measure the exposure levels of the subjects to VX-702. Specifically, the output consisted of:
Empirical distribution of exposure metrics (AUC0-∞, Cₘₐₓ, C₂₄ hours) (FIG. 4, FIG. 5, and FIG. 6);
The predicted safety factors for humans at each dose level (Table 2); and

Pharmacodynamic response: ex vivo LPS stimulated cytokine production.

TABLE 2
(A)

| | | | 2.5 | 5 | 10 | 20 | 40 | 80 |
|---|---|---|---|---|---|---|---|---|
| Scenario | % F | KA | mg | mg | mg | mg | mg | mg |
| 1 | 50% | 0.4 | 61 | 29 | 15 | 7 | 4 | 2 |
| 2 | 50% | 0.1 | 67 | 32 | 16 | 8 | 4 | 2 |
| 3 | 25% | 0.4 | 132 | 61 | 29 | 14 | 7 | 4 |

(B)

| | | | 2.5 | 5 | 10 | 20 | 40 | 80 |
|---|---|---|---|---|---|---|---|---|
| Scenario | % F | KA | mg | mg | mg | mg | mg | mg |
| 1 | 50% | 0.4 | 26 | 12 | 6 | 3 | 2 | 1 |
| 2 | 50% | 0.1 | 27 | 13 | 7 | 3 | 2 | 1 |
| 3 | 25% | 0.4 | 57 | 26 | 12 | 6 | 3 | 2 |

The predicted safety margins at each dose level are calculated as the ratio of the AUC_{0-Y}from the 28-day monkey toxicology study to the predicted median (A) or 95^{th} percentile (B) AUC_{0-Y} in humans.

1. A method for determining the distribution of at least one outcome resulting from the administration of a compound to at least one human, comprising the steps of:
(a) using non-linear mixed effects modeling to determine a value and a standard error for each of a plurality of allometric parameters;
(b) inputting said value and said standard error of at least one of said plurality of allometric parameters into a stochastic pharmacokinetic model, wherein said allometric parameter is designated as a random variable; and
(c) using said stochastic pharmacokinetic model to computationally simulate administration of said compound to said human to produce said distribution of said outcome.

2. The method according to claim 1, wherein at each of said allometric parameter is designated as a random variable with a specified probability density in said stochastic pharmacokinetic model.

3. The method according to claim 2, wherein said random variable has a mean value equal to the value of said allometric parameter, and a standard deviation equal to said standard error of said allometric parameter.

4. The method according to claim 3, wherein said specified probability density corresponds to either a normal distribution or a lognormal distribution.

5. The method according to claim 1, wherein said outcome is selected from AUC, Cmax, C24, Cavg, Cmin, or a pharmacodynamic response.

6. The method according to claim 5, wherein said pharmacokinetic response is selected from AUC, or Cmax.

7. The method according to claim 5, wherein said pharmacodynamic response is selected from inhibition or stimulation of a biological target.

8. The method according to claim 1, wherein said allometric parameter correspond to an allometically scaled pharmacokinetic parameter selected from clearance, volume distribution, or inter-compartmental volume.

9. The method according to claim 8, wherein said pharmacokinetic parameter is CL or V.

10. A method for selecting an optimal dose range of a compound for administration for the first time to a human, comprising the steps of:
(a) selecting one or more outcomes and distribution thereof derived according to the method of claim 1;
(b) based on said distribution selecting a minimum dose level corresponding to a desired level of safety or a desired minimum pharmacological effect; and
(c) based on said distribution selecting a maximum dose level corresponding to a desired level of safety and a desired maximal pharmacological effect.

11. An optimal dose range of a compound for administration for the first time to a human, wherein said optimal dose range is selected according to claim 10.
